(19) United States
(12) Patent Application Publication
(10) Pub. No.: US 2002/0049793 A1
(43) Pub. Date: Apr. 25, 2002

(54) Electronic mail transfer apparatus and electronic mail apparatus

(76) Inventors: Akihiro Okumura, Tokyo (JP); Yoshitaka Hamaguchi, Tokyo (JP)

Correspondence Address: RABIN & CHAMPAGNE, PC, 1101 14TH STREET, NW, SUITE 500, WASHINGTON, DC, 20005, US

(21) Appl. No.: 09/948,711

(22) Filed: Sep. 10, 2001

(30) Foreign Application Priority Data
Oct. 20, 2000 (JP) 2000-320133

(51) Int. Cl. G06F 15/00

(52) U.S. Cl. 707/526

(57) ABSTRACT

An electronic mail transferring apparatus is capable of displaying an important sentence even if only a starting portion of a text of an electronic mail can be displayed. The apparatus has an electronic mail storing part for storing an electronic mail received by a receiving part, an abstraction processing part for extracting an important sentence from a text of an electronic mail stored in the electronic mail storing part, an abstraction result adding part for adding the important sentence extracted by the abstraction processing part to the head of the text of the electronic mail, and a transmitting part for transmitting the resulting electronic mail.

### BACKGROUND OF THE INVENTION

1. Field of the Invention

The present invention relates to an electronic mail transfer apparatus and an electronic mail apparatus which extract an important sentence from a text of an electronic mail to add information on the important sentence to the electronic mail.

2. Description of the Related Art

A mailer, which transmits and receives as well as manages electronic mails, is generally provided with a function of displaying a text of an electronic mail, and a function of displaying a list of saved electronic mails. A user can generally know saved electronic mails from the electronic mail list and specify an electronic mail to view for reading a text of the specified electronic mail.

Generally, electronic mail lists often display a portion of information in a header section such as a sender and subject. For example, Outlook, a mailer manufactured by Microsoft Corporation, can display the first several lines of an electronic mail text in addition to a header section.

Conventional mailers display an electronic mail list which includes information associated with respective electronic mails such as transmission date and time, sender name, subject, and presence or absence of attached file. However, such information alone causes the user to have difficulties in confirming contents of electronic mails sent to the user. Also, even if contents can be understood to some degree, users are accustomed to send a return mail only by appending “Re:” to the subject of an original mail, so that it is difficult to understand contents of the return mail only from information read from the subject. In addition, information in the original mail is referenced in the contents of the return mail by adding a symbol such as “>” to the referenced information, so that it is difficult to understand the contents of the return mail if a lot of such reference information pieces is included therein.

As a mailer which implements a function of displaying a portion of contents, Outlook, the mailer manufactured by Microsoft Corporation, for example, is capable of extracting the first several lines of electronic mail texts for displaying them in a saved electronic mail list. While this function is intended to compensate to some degree for information which cannot be acquired from the header section, this function does not always serve in an effective manner since every electronic mail does not include its subject matter in the first several lines.

### OBJECT AND ABSTRACT OF THE INVENTION

The present invention employs the following configurations for solving the aforementioned problems.

<Configuration 1>

An electronic mail transfer apparatus comprises an abstraction processing part for extracting an important sentence from a text of an electronic mail, an abstraction result adding part for adding the important sentence extracted by the abstraction processing part to the text of the electronic mail, and a transmitting part for transmitting the electronic mail processed by the abstraction result adding part.

<Configuration 2>

The electronic mail transfer apparatus set forth in Configuration 1, further comprises an abstraction result adding part for adding the important sentence to the head of the text.

<Configuration 3>

An electronic mail transfer apparatus comprises an abstraction processing part for extracting information on a position of an important sentence from a text of an electronic mail, an abstract position adding part for creating an abstract information field indicative of the information on the position of the important sentence extracted by the abstraction processing part, and adding the abstract information field to a header of the electronic mail, and a transmitting part for transmitting the electronic mail processed by the abstract position adding part.

<Configuration 4>

An electronic mail transfer apparatus comprises an abstraction processing part for extracting information on a position of an important sentence from a text of an electronic mail, an abstract position adding part for adding the information on the position of the important sentence extracted by the abstraction processing part to the text of the electronic mail, and a transmitting part for transmitting the electronic mail processed by the abstract position adding part.

<Configuration 5>

An electronic mail transfer apparatus comprises an abstraction processing part for extracting an important sentence from a text of an electronic mail, a subject changing part for specifying the important sentence extracted by the abstraction processing part as a subject of the electronic mail, and a transmitting part for transmitting the electronic mail which has the subject changed by the subject changing part.

<Configuration 6>

The electronic mail transfer apparatus set forth in Configuration 5, wherein the subject changing part specifies the important sentence extracted by the abstraction processing part as a subject of the electronic mail only when the subject of the electronic mail begins with a character string indicative of a return mail followed by a symbol or a blank.

<Configuration 7>

An electronic mail apparatus comprises an abstraction processing part for extracting information on a position of an important sentence from a text of an electronic mail, an abstract position adding part for creating an abstract information field from the information on the position of the important sentence extracted from the abstraction processing part, and adding the abstract information field to a header of the electronic mail, an electronic mail saving part for saving an electronic mail having the abstract information field added thereto by the abstract position adding part, an abstract position interpreting part responsive to a request from a user for displaying an electronic mail in the electronic mail saving part, for interpreting an abstract information field of the requested electronic mail to identify a range of an important sentence of the electronic mail, and a processing part for instructing to display the range of the important sentence identified by the abstract position interpreting part in a display manner different from a display manner of other portions of the text.

<Configuration 8>

An electronic mail apparatus comprises an abstraction processing part for extracting information on a position of an important sentence from a text of an electronic mail, an abstract position adding part for creating an abstract information field from the information on the position of the important sentence extracted from the abstraction processing part, and adding the abstract information field to a header of the electronic mail, an electronic mail saving part for saving an electronic mail having the abstract information field added thereto by the abstract position adding part, an abstract position interpreting part responsive to a request from a user for displaying an electronic mail saved in the electronic mail saving part in a list view, for interpreting an abstract information field of the requested electronic mail to identify a range of an important sentence of the electronic mail, and a processing part for instructing to display the range of the important sentence identified by the abstract position interpreting part in a list form.

<Configuration 9>

The electronic mail transfer apparatus set forth in Configuration 3 or 4, or an electronic mail apparatus set forth in Configuration 7 or 8, wherein the information on a position of an important sentence is a starting position of the important sentence in the text of the electronic mail.

<Configuration 10>

The electronic mail transfer apparatus set forth in Configuration 3 or 4, or an electronic mail apparatus set forth in Configuration 7 or 8, wherein the information on a position of an important sentence includes a starting position and an end position of the important sentence in the text of the electronic mail text.

### BRIEF DESCRIPTION OF THE DRAWINGS

FIG. 1 is a configuration diagram illustrating a first embodiment of an electronic mail transfer apparatus according to the present invention;

FIG. 2 is an explanatory diagram showing a received electronic mail;

FIG. 3 is an explanatory diagram showing a processed electronic mail;

FIG. 4 is a configuration diagram of a second embodiment;

FIG. 5 is an explanatory diagram showing position information added to a header;

FIG. 6 is an explanatory diagram showing a processed electronic mail in the second embodiment;

FIG. 7 is a configuration diagram of a third embodiment;

FIG. 8 is an explanatory diagram showing a processed electronic mail in the third embodiment; and

FIG. 9 is a configuration diagram of a fourth embodiment.

### DETAILED DESCRIPTION OF THE PREFERRED EMBODIMENTS

Preferred embodiments of the present invention will hereinafter be described in detail with reference to the accompanying drawings.

<<First Embodiment>>

<Configuration>

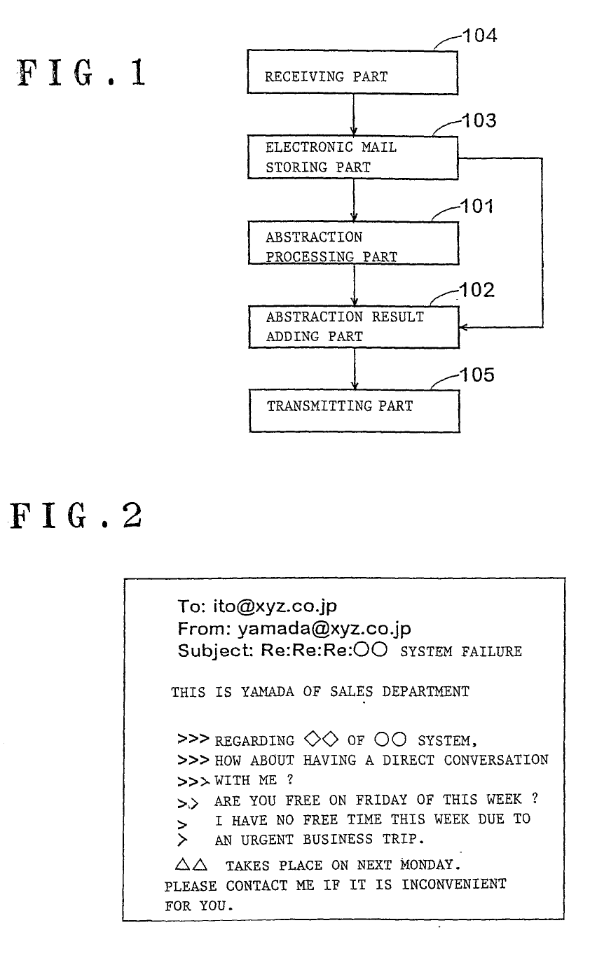

FIG. 1 is a configuration diagram illustrating the first embodiment of an electronic mail transfer apparatus according to the present invention. The illustrated apparatus comprises an abstraction processing part 101, an abstraction result adding part 102, an electronic mail storing part 103; a receiving part 104, and a transmitting part 105.

The abstraction processing part 101 is a functional part for extracting an important sentence from an electronic mail text. The abstraction result adding part 102 is a functional part for adding a sentence extracted by the abstraction processing part 101 to the head of the text. The electronic mail storing part 103 is a storing part for temporarily storing an electronic mail under processing. The receiving part 104 is a functional part for receiving an electronic mail. The transmitting part 105 is a functional part for transmitting an electronic mail which has been processed by the abstraction result adding part 102.

The abstraction processing part 101 and abstraction result adding part 102 are implemented by software having functions corresponding to the respective processing, and hardware such as a processor and a memory for executing the software. The electronic mail storing part 103 in turn is implemented on a storage device such as a semiconductor memory.

<Operation>

First, the receiving part 104 receives an electronic mail under processing which is sent to the electronic mail storing part 103. Next, the abstraction processing part 101 abstracts a text of the electronic mail stored in the electronic mail storing part 103, and sends the result of abstraction to the abstraction result adding part 102. While a variety of methods can be contemplated herein for the abstraction, assume herein that an electronic mail text is abstracted in accordance with the following procedure.

1. An electronic mail under processing is divided into paragraphs. For example, an electronic mail text may be divided by regarding a blank line within the text as a delimiter mark.

2. Search for the paragraph which includes two or more lines that include characters and no referenced line and is located closest to the head of the text. The referenced line is defined as a line which begins with “>” at the head.

3. The paragraph searched by the processing 2 is output as an abstract.

The abstraction result adding part 102 adds the abstract received from the abstraction processing part 101 to the head of the text of the electronic mail stored in the electronic mail storing part 103, and sends the resulting electronic mail to the transmitter 105. Finally, the transmitter 105 transmits the received electronic mail.

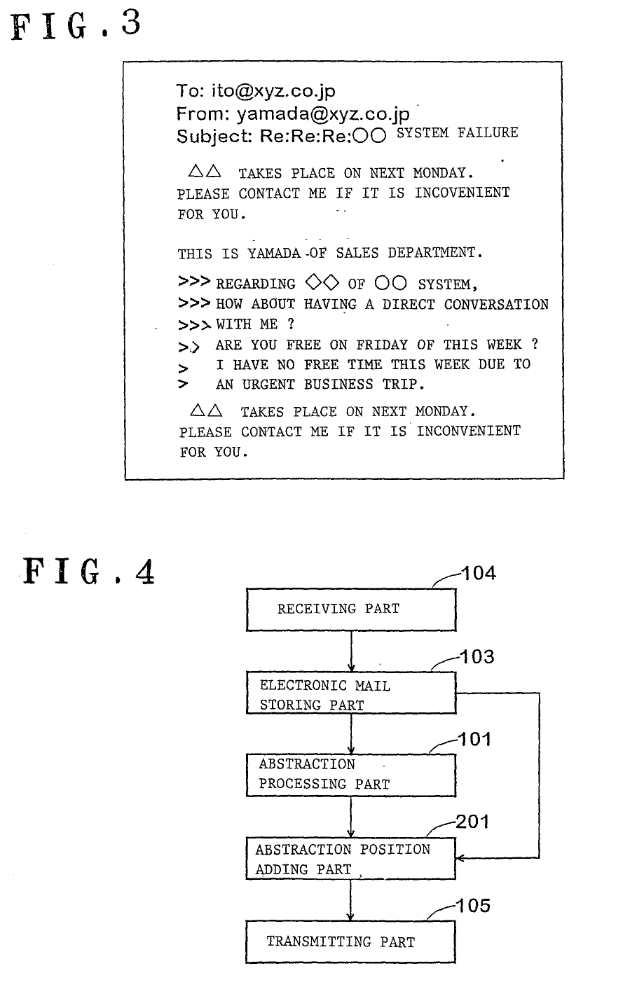

FIG. 2 is an explanatory diagram showing a received electronic mail. FIG. 3 is an explanatory diagram showing a processed electronic mail. As shown in FIG. 2, there are two lines which include characters (resulting in exclusion of the first line “This is Yamada in Sales Department.”), and the first paragraph existing in the text, excluding referenced lines (lines having marks “>>>”, “>>” and “>” at the heads) from the text, i.e.,“ΔΔ takes place on next Monday. Please contact me if it is inconvenient for you.” is extracted as abstract, and added to the head of the text as can be seen in FIG. 3.

<Effects>

As described above, the first embodiment provides the following effects.

Since the abstract is added to the head of the text, the outline can be understood before reading the whole text.

Since the abstract is added to the head of each text, abstracts can be read in a list view, when using a mailer which is capable of displaying the first several lines of a text in the list view, as described in the prior art.

For transmitting an electronic mail to a terminal such as a mobile telephone which is limited in the number of received characters, even if contents of an electronic mail breaks off in the middle, the abstract added to the head of the mail allows the user to understand the outline.

Since the abstraction is performed during a transfer of an electronic mail, the abstraction can be intensively managed.

Since the abstraction is performed during a transfer of an electronic mail, a receiving terminal is not burdened with a load for the abstraction. Thus, the present invention can be utilized without any problem by a terminal which has a relatively low performance such as a mobile terminal.

<<Second Embodiment>>

The second embodiment adds a starting position and an end position of an important portion instead of the addition of an abstract in the first embodiment.

<Configuration>

FIG. 4 is a configuration diagram of the second embodiment. The illustrated apparatus comprises an abstraction processing part 101, an electronic mail storing part 103, a receiving part 104, a transmitting part 105, and an abstract position adding part 201. In the second embodiment, the configuration excluding the abstract position adding part 201 is similar to the first embodiment, so that corresponding parts are designated the same reference numerals, and description thereon is omitted.

The abstract position adding part 201 has a function of creating an abstract information field from information on the position of an important sentence, extracted by the abstraction processing part 101, in a text, and adding the abstract information field to a header of an electronic mail. The abstract position adding part 201 is implemented by software having a function corresponding to its processing, and hardware such as a processor and a memory required for executing the software.

<Operation>

First, the receiving part 104 receives an electronic mail under processing which is sent to the electronic mail storing part 103. Next, the abstraction processing part 101 abstracts a text of the electronic mail stored in the electronic mail storing part 103, and sends to the abstract position adding part 201 a starting position and an end position in a resulting text from the abstraction within the text. An abstracting method used in the second embodiment is assumed to be similar to that used in the first embodiment.

The abstract position adding part 201 creates a new field from the position information received from the abstraction processing part 101, adds the field to a header of the electronic mail stored in the electronic mail storing part 103, and sends the resulting electronic mail to the transmitting part 105. For example, when determining that contents from the 170th byte to 230th byte of the text comprise an important sentence (i.e., abstract), one line of the position information is added to the header of the electronic mail.

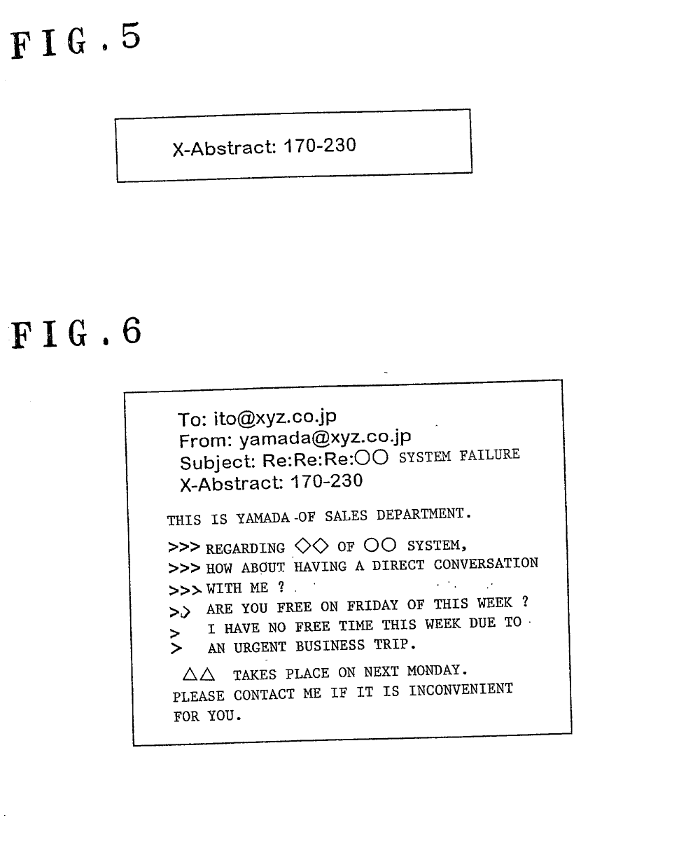

FIG. 5 is an explanatory diagram showing position information added to a header.

In the shown example, “X-Abstract” indicates a field name representative of the position of an abstract. However, this is a name merely used by way of example, and any name may be used as long as it is a field name referenced by a mailer, later described.

The transmitting part 105, upon receipt of the electronic mail which has the field representative of the position of the abstract added to the header section, transmits the electronic mail based on the information in the header.

A mailer for receiving the electronic mail as described has a function of recognizing a range of the important sentence within the text based on the information in the field, when “X-Abstract” is found in the received header section.

Thus, the mailer which has received this electronic mail can know the important portion of the electronic mail by referencing the “X-Abstract” field. It is therefore possible to display the important portion when an electronic mail list is displayed, and to display the important portion in a display manner different from a display manner of other portions of the text when the text of the electronic mail is displayed. For instance, it is possible to emphasize the important portion by changing the color, font, size of character in the important portion when the text of the electronic mail is displayed.

FIG. 6 is an explanatory diagram showing a processed electronic mail in the second embodiment.

The shown electronic mail is the result of processing the electronic mail shown in FIG. 2. “X-Abstract: 170-230” indicative of information on the position of the important portion is added to the header section. A mailer, which has received this electronic mail, emphasizes the important portion by changing the color, font or size of characters in the portion “ΔΔ takes place on next Monday. Please contact me if it is inconvenient for you.” which exists from the 170th byte to 230th byte of the text.

<Effects>

As described above, since information on the position of an important portion in a text is added to a header of a mail to be transferred, the second embodiment provides the following effects.

When an important portion is displayed in a list view, contents can be readily understood even with a less amount of display.

When an important portion is displayed with emphasis, the user will not overlook the important portion.

<<Third Embodiment>>

The third embodiment replaces the result of abstraction, regarded as a subject, with an original subject, instead of the addition of an abstract in the first embodiment and the addition of the position of an abstract in the second embodiment.

<Configuration>

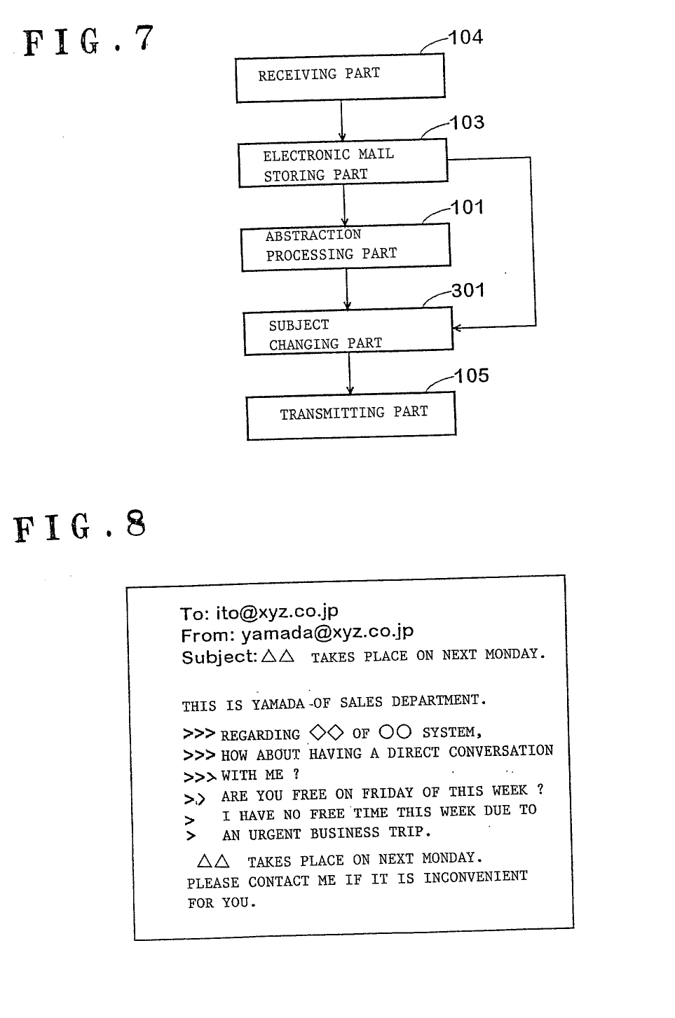

FIG. 7 is a configuration diagram of the third embodiment. The illustrated apparatus comprises an abstraction processing part 101, an electronic mail storing part 103, a receiving part 104, a transmitting part 105, and a subject changing part 301. In the third embodiment, the configuration excluding the subject changing part 301 is similar to Embodiments 1, 2, so that corresponding parts are designated the same reference numerals, and description thereon is omitted.

The subject changing part 301 has a function of changing the value of a subject field in a header section of an electronic mail of interest to an important sentence extracted in the abstraction processing part 101. Also, the subject changing part 301 is implemented by software having a function corresponding to its processing, and hardware such as a processor and a memory required for executing the software.

<Operation>

First, the receiving part 104 receives an electronic mail under processing which is sent to the electronic mail storing part 103. Next, the abstraction processing part 101 abstracts a text of the electronic mail stored in the electronic mail storing part 103, and sends the result of abstraction to the subject changing part 301. An abstracting method used in the third embodiment is assumed to be similar to that used in the first and second embodiments.

The subject changing part 301 replaces the first sentence in the result of abstraction received from the abstraction processing part 101, as a subject, with an original subject, and sends the resulting text to the transmitting part 105. For example, when determining sentences, “ΔΔ takes place on next Monday. Please contact me if it is inconvenient for you.” of the text as important sentences (i.e., abstract), the first sentence “ΔΔ takes place on next Monday.” is chosen as the subject. The sentence may be recognized based on information such as “.”, “?”, “!” or blank.

FIG. 8 is an explanatory diagram showing a processed electronic mail in the third embodiment. The shown electronic mail is the result of processing the electronic mail shown in FIG. 2. The subject filed in the header section is changed to “ΔΔ takes place on next Monday.” indicative of an important sentence. It should be noted that while a Japanese sentence is displayed as it is in the subject in the shown example for making the description readily understandable, the Japanese sentence may be required to be MIME encoded, when utilized in practice.

<Effects>

As described above, since an important sentence is used as the subject in the header section in place of an original subject, the third embodiment provides the following effects.

An improper subject, possibly resulting from returning or repeated returning, can be eliminated.

A conventional mailer can be used as it is.

<<Fourth Embodiment>>

The fourth embodiment adds the function of the second embodiment to an ordinary electronic mail apparatus.

<Configuration>

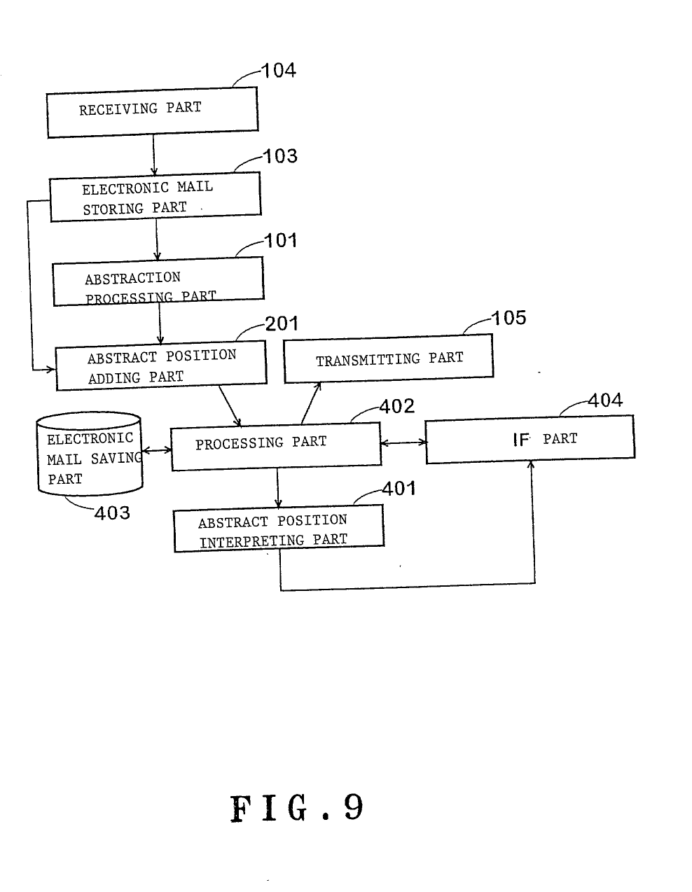

FIG. 9 is a configuration diagram of the fourth embodiment. The illustrated example comprises an abstraction processing part 101, an electronic mail storing part 103, a receiving part 104, a transmitting part 105, an abstract position adding part 201, an abstract position interpreting part 401, a processing part 402, an electronic mail saving part 403, and an IF part 404. In the fourth embodiment, the configuration excluding the abstract position interpreting part 401, processing part 402, electronic mail saving part 403, and IF part 404 is similar to Embodiments 2, so that corresponding parts are designated the same reference numerals, and description thereon is omitted.

The abstract position interpreting part 401 is a functional part for interpreting contents of a field to acquire a range of an important portion from the result of abstraction. The processing part 402 is a functional part for governing a variety of processing associated with an electronic mail. For example, the processing part 402 is capable of transmitting a specified electronic mail to the transmitting part 105 in response to an electronic mail transmitting instruction input from the IF part 404, and reading an electronic mail from the electronic mail saving part 403 and issuing a display instruction to the IF part 404 when it is instructed to display the electronic mail. The electronic mail saving part 403 is a functional part for saving received electronic mails, incomplete electronic mails and so on. The IF part 404 provides a user interface for the apparatus. The abstract position interpreting part 401 and processing part 402 are implemented by software having functions corresponding to their respective processing, and hardware such as a processor and a memory required for executing the software. The electronic mail saving part 403 is implemented on a storage device such as a hard disk drive.

<Operation>

The fourth embodiment operates as a whole as an electronic mail apparatus for reading and writing an electronic mail. Since the fourth embodiment differs from general electronic mail apparatus only in operations involved in “receipt of an electronic mail,” “display of an electronic mail text,” and “display of an electronic mail list,” the following description will be made only on these operations, while description on the remaining operations is omitted.

1. Operation Upon Receipt

First, the receiving part 104 receives an electronic mail under processing which is sent to the electronic mail storing part 103. Next, the abstraction processing part 101 abstracts a text of the electronic mail stored in the electronic mail storing part 103, and sends to the abstract position adding part 201 a starting position and an end position in a resulting text from the abstraction within the text. An abstracting method used herein is similar to that used in Embodiments 1-3.

The abstract position adding part 201 creates a new field from the position information received from the abstraction processing part 101, adds the field to a header of the electronic mail stored in the electronic mail storing part 103, and sends the resulting electronic mail to the processing part 402. The processing part 402 saves this electronic mail in the electronic mail saving part 403.

2. Display of Electronic Mail Text

The processing part 402, upon receipt of an instruction from the IF part 404 to display an electronic mail, retrieves the specified electronic mail from the electronic mail saving part 403, and sends it to the abstract position interpreting part 401. The abstract position interpreting part 401 identifies the range of an important sentence with reference to the field which was added upon receipt. The abstract position interpreting part 401 delivers the electronic mail to the IF part 404, and requests the same to display the electronic mail as well as put emphasis on the range of displayed important sentence.

3. Display of Electronic Mail List

As previously described in connection with the prior art, there have been mailers available which display first several lines of each electronic mail text. In the fourth embodiment, an important sentence identified by a method similar to the foregoing “2. Display of Electronic Mail Text” is displayed instead of displaying the first several lines of a text.

<Effects>

As described above, since information on the position of an important sentence is extracted from a received electronic mail and added to the header such that the important sentence is displayed with emphasis or in a list view based on the information on the position of the important sentence, the fourth embodiment provides the following effects.

Since the abstraction has been performed upon receipt of an electronic mail, the user is free from a waiting time for the abstraction, unlike the abstraction performed upon “displaying an electronic mail text” or “displaying an electronic mail list.”

Since the abstraction is performed after receipt of an electronic mail, the abstraction can be performed in accordance with a particular environment in which the electronic mail is received (for example, the type of a terminal and so on).

<<Manner of Utilization>>

While the first embodiment adds an abstract to the head of a text, the position at which the abstract is added is not limited to the head of the text. Alternatively, the abstract may be added to an arbitrary position in the text, or in a header section. It should be noted however that when the abstract is added to the header section, a field name should be additionally set, and a field body is included in the abstract as is the case with the second embodiment.

While the second embodiment is configured to add an abstract position to a header, the abstract position may be added to a text.

While the second embodiment is configured to send a starting position and an end position within a resulting text after the abstraction, the starting position only may be sent.

While the third embodiment is configured to choose the first sentence in the result of abstraction as a subject, the subject is not limited to the first sentence. Alternatively, a portion or entirety of the result of abstraction may be utilized as a subject.

While the third embodiment replaces a subject at all times, the replacement may be made only when an original subject begins with “Re” followed by a symbol or a blank. In other words, even if an original subject begins with “Re”, the original subject is not replaced if it has another meaning such as “Rental . . . ”

While the third embodiment has been described in connection with a character string “Re” indicative of a return mail, the present invention is not limited to this particular character string, but may be applied to any character string.

What is claimed is:

1. An electronic mail transfer apparatus comprising:
an abstraction processing part for extracting an important sentence from a text of an electronic mail;
an abstraction result adding part for adding the important sentence extracted by said abstraction processing part to the text of said electronic mail; and
a transmitting part for transmitting said electronic mail processed by said abstraction result adding part.

2. An electronic mail transfer apparatus according to claim 1, further comprising:
an abstraction result adding part for adding the important sentence to the head of the text.

3. An electronic mail transfer apparatus comprising:
an abstraction processing part for extracting information on a position of an important sentence from a text of an electronic mail;
an abstract position adding part for creating an abstract information field indicative of the information on the position of the important sentence extracted by said abstraction processing part, and adding said abstract information field to a head of said electronic mail; and
a transmitting part for transmitting said electronic mail processed by said abstract position adding part.

4. An electronic mail transfer apparatus comprising:
an abstraction processing part for extracting information on a position of an important sentence from a text of an electronic mail;
an abstract position adding part for adding the information on the position of the important sentence extracted by said abstraction processing part to the text of said electronic mail; and
a transmitting part for transmitting said electronic mail processed by said abstract position adding part.

5. An electronic mail transfer apparatus comprising:
an abstraction processing part for extracting an important sentence from a text of an electronic mail;
a subject changing part for specifying the important sentence extracted by said abstraction processing part as a subject of said electronic mail; and
a transmitting part for transmitting said electronic mail which has the subject changed by said subject changing part.

6. An electronic mail transfer apparatus according to claim 5, wherein:
said subject changing part specifies the important sentence extracted by said abstraction processing part as a subject of said electronic mail only when the subject of the electronic mail begins with a character string indicative of a return mail followed by a symbol or a blank.

7. An electronic mail apparatus comprising:
an abstraction processing part for extracting information on a position of an important sentence from a text of an electronic mail;
an abstract position adding part for creating an abstract information field from the information on the position of the important sentence extracted from said abstraction processing part, and adding the abstract information field to a header of said electronic mail;
an electronic mail saving part for saving an electronic mail having the abstract information field added thereto by said abstract position adding part;
an abstract position interpreting part responsive to a request from a user for displaying an electronic mail in said electronic mail saving part, for interpreting an abstract information field of the requested electronic mail to identify a range of an important sentence of said electronic mail; and
a processing part for instructing to display the range of the important sentence identified by said abstract position interpreting part in a display manner different from a display manner of other portions of the text.

8. An electronic mail apparatus comprising:
an abstraction processing part for extracting information on a position of an important sentence from a text of an electronic mail;
an abstract position adding part for creating an abstract information field from the information on the position of the important sentence extracted from said abstraction processing part, and adding the abstract information field to a header of said electronic mail;
an electronic mail saving part for saving an electronic mail having the abstract information field added thereto by said abstract position adding part;
an abstract position interpreting part responsive to a request from a user for displaying an electronic mail saved in said electronic mail saving part in a list view, for interpreting an abstract information field of the requested electronic mail to identify a range of an important sentence of said electronic mail; and
a processing part for instructing to display the range of the important sentence identified by said abstract position interpreting part in a list form.

9. An electronic mail transfer apparatus according to claim 3 or 4, wherein:
said information on a position of an important sentence is a starting position of the important sentence in the text of the electronic mail.

10. An electronic mail apparatus according to claim 7 or 8, wherein:
said information on a position of an important sentence is a starting position of the important sentence in the text of the electronic mail.

11. An electronic mail transfer apparatus according to claim 3 or 4, wherein:
said information on a position of an important sentence includes a starting position and an end position of the important sentence in the text of the electronic mail.

12. An electronic mail apparatus according to claim 7 or 8, wherein:
said information on a position of an important sentence includes a starting position and an end position of the important sentence in the text of the electronic mail.
